(19) United States
(12) Patent Application Publication
(10) Pub. No.: US 2016/0372745 A1
(43) Pub. Date: Dec. 22, 2016

(54) NEGATIVE ELECTRODE ACTIVE MATERIAL FOR LITHIUM SECONDARY BATTERY

(71) Applicant: ILJIN ELECTRIC CO., LTD., Hwaseong (KR)

(72) Inventors: Young Pil Choi, Chungju (KR); Cheol Ho Park, Gwangmyeong (KR); Seon Kyong Kim, Seoul (KR); Hyang Yeon Kim, Seoul (KR); Seung Chul Lee, Seoul (KR); Jae Woong Kim, Daejeon (KR); Min Seok Sung, Hwaseong (KR)

(73) Assignee: ILJIN ELECTRIC CO., LTD., Hwaseong (KR)

(21) Appl. No.: 15/117,449

(22) PCT Filed: Feb. 10, 2015
(86) PCT No.: PCT/KR2015/001329

§ 371 Date: Aug. 9, 2016

(30) Foreign Application Priority Data
Feb. 14, 2014 (KR) 10-2014-0017433

(51) Int. Cl. H01M 4/46; H01M 4/134; C22C 30/02; B22D 25/04; C22C 1/02; B22D 11/06; B22D 11/00; H01M 10/0525; C22C 28/00

(52) U.S. Cl. CPC H01M 4/463; H01M 10/0525; H01M 4/134; C22C 30/02; C22C 28/00; C22C 1/02; B22D 11/0611; B22D 11/001; B22D 25/04

(57) ABSTRACT

A negative electrode active material for a lithium secondary battery according to an exemplary embodiment of the present invention includes an alloy including silicon (Si), copper (cu), and aluminum (Al) of 40 to 70 at %, wherein the ratio of aluminum (Al) to copper (Cu) included in the alloy is substantailly 10:90 to 30:70, and the alloy further includes iron (Fe), and further includes zirconium (Zr) or titanium (Ti).

### TECHNICAL FIELD

The present invention relates to a negative electrode active material for a lithium secondary battery, and more particularly, to a negative electrode active material for a lithium secondary battery having an excellent life characteristic and an excellent capacity maintaining characteristic.

### BACKGROUND ART

A lithium battery in the related art uses a lithium metal as a negative electrode active material, but when a lithium metal is used, a battery is short-circuited by formation of dendrite to cause danger of explosion, so that a carbon-based material is widely used as a negative electrode active material, instead of a lithium metal.

The carbon-based active material includes crystalline carbon, such as natural graphite and artificial graphite, and amorphous carbon, such as soft carbon and hard carbon. However, the amorphous carbon has a large capacity, but has a problem in that irreversibility is large during a charging/discharging process. Graphite is representatively used as the crystalline carbon, and has a theoretical limit capacity of 372 mAh/g, which is large, so that the graphite is used as a negative electrode active material.

In order to develop a next-generation high capacity lithium battery, a development of a negative electrode active material having a high capacity beyond the capacity of graphite is essential. To this end, a material, which is currently and actively researched, is a silicon-based negative electrode active material. The silicon has a high capacity and a high energy density, and is capable of occluding and discharging more lithium ions than those of the negative electrode active material using the carbon-based material, so that it is possible to manufacture a secondary battery having a high capacity and a high energy density.

However, when the silicon-based negative electrode active material is applied to a lithium secondary battery, there is a problem in that the occluding and discharging are repeated during the charging/discharging process, thereby degrading a life characteristic of the lithium secondary battery. Further, as the usage of the mobile devices, such as mobile phones and notebook computers, has been recently and sharply increased, the importance of a life characteristic of the secondary battery, as well as a high capacity characteristic, has been more emphasized.

Accordingly, a silicon-based negative electrode active material, which is capable of maintaining a high capacity characteristic of silicon, and is capable of considerably improving a life characteristic of a secondary battery, has been continuously demanded.

### DETAILED DESCRIPTION OF THE INVENTION

### Technical Problem

An object of the present invention is to provide a negative electrode active material for a lithium secondary battery with an improved life characteristic.

Another object of the present invention is to provide a negative electrode active material for a lithium secondary battery having an excellent capacity maintaining characteristic.

Objects of the present invention are not limited to the objects described above, and other objects that are not described will be clearly understood by a person skilled in the art from the description below.

### Technical Solution

In order to achieve the aforementioned object, a negative electrode active material for a lithium secondary battery according to an exemplary embodiment of the present invention includes an alloy including silicon (Si), copper (cu), and aluminum (Al) of 40 to 70 at %, wherein the ratio of aluminum (Al) to copper (Cu) included in the alloy is substantially 10:90 to 30:70, and the alloy further includes iron (Fe), and further includes zirconium (Zr) or titanium (Ti).

The degree of amorphization of the alloy may be 40% or more.

The alloy may include iron (Fe) of 0.1 to 10 at %.

The alloy may include zirconium (Zr) of 0.1 to 10 at %.

The alloy may include titanium (Ti) of 0.1 to 10 at %.

Other detailed matters of the embodiments are included in the detailed description and the drawings.

### Advantageous Effects

The present invention has an effect in providing a negative electrode active material for a lithium secondary battery with an improved life characteristic.

The present invention has an effect in providing a negative electrode active material for a lithium secondary battery having an excellent capacity maintaining characteristic

Effects of the present invention are not limited to the objects described above, and other effects that are not described will be clearly understood by a person skilled in the art from the description below.

### BRIEF DESCRIPTION OF DRAWINGS

FIGS. 1A to 1F are SEM pictures of enlarged negative electrode active materials of Examples 1 to 3, and Comparative Examples 1 to 3.

FIGS. 2A to 2D are XRD data of the negative electrode active materials of Examples 1 to 3, and Comparative Examples 1 to 3

FIGS. 3A-3B illusrate an example for explaining a calculation of the degree of amorphization based on an XRD pattern.

FIG. 4 is a table representing calculated degrees of amorphization of the negative electrode active materials of Examples 1 to 3, and Comparative Examples 1 to 3.

FIG. 5 is a table representing an active material charging quantity and an active material discharging quantity of the negative electrode active materials of Examples 1 to 3, and Comparative Examples 1 to 3.

FIG. 6 is a graph representing a cycle life characteristic of the negative electrode active materials of Examples 1 to 3, and Comparative Examples 1 to 3.

### BEST MODE

A negative electrode active material for a lithium secondary battery according to an exemplary embodiment of the present invention for achieving the aforementioned object includes an alloy including silicon (Si), copper (cu), and aluminum (Al) of 40 to 70 at %, wherein the ratio of aluminum (Al) to copper (Cu) included in the alloy is substantailly 10:90 to 30:70, and the alloy further includes iron (Fe), and further includes zirconium (Zr) or titanium (Ti).

### MODE FOR CARRYING OUT THE INVENTION

Various advantages and features of the present disclosure and methods accomplishing thereof will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention. Therefore, the present invention will be defined only by the scope of the appended claims.

Respective characteristics of several exemplary embodiments of the present disclosure may be partially or entirely coupled or combined, and technically and variously connected and driven enough for those skilled in the art to fully understand, and respective exemplary embodiments may be independently carried out, and implemented together according to an associated relation.

The term “approximate” used in the present specification is used as a numerical value or a meaning close to the numerical value when an unique manufacturing and material allowable error is suggested to a mentioned meaning, and is used for preventing an unconscionable infringer from illegally using the disclosed contents including an accurate or absolute numerical value mentioned for helping the understanding of the present invention.

A unit “%” used in the present specification means “atom %” unless otherwise regulated.

The present invention provides a negative electrode active material for a lithium secondary battery, which includes an alloy including silicon (Si), copper (Cu), and aluminum (Al), and further including zirconium (Zr) or titanium (Ti), in which the ratio of aluminum (Al) to copper (Cu) included in the alloy is substantially 10:90 to 30:70.

In the present invention, silicon (Si) may be involved in occlusion and discharging of lithium ions when a negative electrode active material is used as a battery. In the present invention, silicon (Si) is included in the alloy by 40 to 70 at %.

The quantity of silicon (Si) included in the alloy is related to a capacity and a life characteristic of the negative electrode active material. Particularly, when more silicon (Si) is included in the alloy, a capacity of the negative electrode active material may be improved, but a life characteristic may be slightly degraded.

In the present invention, copper (Cu) and aluminum (Al) form a metal matrix in which silicon (Si) is dispersible. Copper (Cu) and aluminum (Al) may form a metal matrix while forming a solid solution or a intermetallic compound.

As described above, the ratio of aluminum (Al) to copper (Cu) included in the alloy is substantially 10:90 to 30:70. Here, the fact that the ratio of the two metals included in the alloy substantially corresponds to a specific numerical value means that the two metals included in the alloy are added by specific numerical values within an error range of a process.

As will be further described below, the ratio of aluminum (Al) to copper (Cu) included in the alloy is related to a capacity and a life characteristic of the negative electrode active material. Particularly, when the ratio of aluminum (Al) to copper (Cu) is increased, a capacity of the negative electrode active material is degraded, but a life characteristic thereof is improved, and when the ratio of aluminum (Al) to copper (Cu) is decreased, a capacity of the negative electrode active material is improved, but a life characteristic thereof is degraded.

In the present invention, the ratio of aluminum (Al) to copper (Cu) included in the alloy is designed to be relatively low, that is, substantially 10:90 to 30:70. In this case, a life characteristic of the negative electrode active material may be slightly degraded, but as will be described below, titanium (Ti) and zirconium (Zr) additionally added to the alloy may considerably improve a life characteristic of the negative electrode active material.

Iron (Fe) is added to the alloy composed of silicon (Si), copper (Cu), and aluminum (Al) to improve a charging quantity and a discharging quantity of the negative electrode active material. The ratio of iron (Fe) added to the alloy may be 0.1 to 10 at %, but is not essentially limited thereto.

In the present invention, titanium (Ti) is added to the alloy composed of silicon (Si), copper (Cu), aluminum (Al), and iron (Fe) to improve a life characteristic of the negative electrode active material . The ratio of titanium (Ti) added to the alloy may be 0.1 to 10 at %, but is not essentially limited thereto.

In the present invention, zirconium (Zr) is added to the alloy composed of silicon (Si), copper (Cu), aluminum (Al), and iron (Fe) to improve a life characteristic of the negative electrode active material. The ratio of zirconium (Zr) added to the alloy may be 0.1 to 10 at %, but is not essentially limited thereto.

As described above, the alloy of the present invention includes titanium (Ti) or zirconium (Zr). Accordingly, only titanium (Ti) may be added, only zirconium (Zr) may be added, or both titanium (Ti) and zirconium (Zr) may be added to the alloy of the present invention.

In the present invention, the degree of amorphization may be 40% or more.

Here, the degree of amorphization is a value numerically representing the degree of amorphous region, not a crystalline region, which is included in the alloy, and as further described below, the degree of amorphization may be obtained by analyzing a result of XRD data.

The relatively high degree of amorphization may positively influence the improvement of a life characteristic of the negative electrode active material.

### EXAMPLE 1

A method of manufacturing the negative electrode active material of the present invention is nor particularly limited, and for example, various fine powder preparing methods (a gas atomizer method, a centrifugal gas atomizer method, a plasma atomizer method, a rotating electrode method, and a mechanical alloy method) publicly known in the art may be used.

In Example 1, a negative electrode active material having a composition of Si₅₀(Cu₂₀Al₈₀)₄₀Fe₅Ti₅ was fabricated by mixing silicon (Si), copper (Cu), aluminum (Al), iron (Fe), and titanium (Ti), melting the mixture by an arc melting method and the like, and applying a single roll rapid solidification method, which sprays the melt to a rotating copper roll.

### EXAMPLE 2

In Example 2, a negative electrode active material was fabricated by the same manner as that of Example 1 except that a composition of the negative electrode active material is Si₅₀(Cu₂₀Al₈₀)_{42.5}Fe₅Zr_{2.5}.

### EXAMPLE 3

In Example 3, a negative electrode active material was fabricated by the same manner as that of Example 3 except that a composition of the negative electrode active material is Si₆₀(Cu₂₀Al₈₀)₃₀Fe₅Ti₅.

### COMPARATIVE EXAMPLE 1

In Comparative Example 1, a negative electrode active material was fabricated by the same manner as that of Example 1 except that a composition of the negative electrode active material is Si₅₀(Cu₆₁Al₃₉)₅₀.

### COMPARATIVE EXAMPLE 2

In Comparative Example 2, a negative electrode active material was fabricated by the same manner as that of Example 1 except that a composition of the negative electrode active material is Si₅₀(Cu₂₀Al₈₀)₅₀.

### COMPARATIVE EXAMPLE 3

In Comparative Example 3, a negative electrode active material was fabricated by the same manner as that of Example 1 except that a composition of the negative electrode active material is Si₆₀(Cu₅₀Al₅₀)₃₅Fe₅.

SEM Analysis

A Scanning Electron Microscopy (SEM) analysis was performed on the fabricated negative electrode active materials

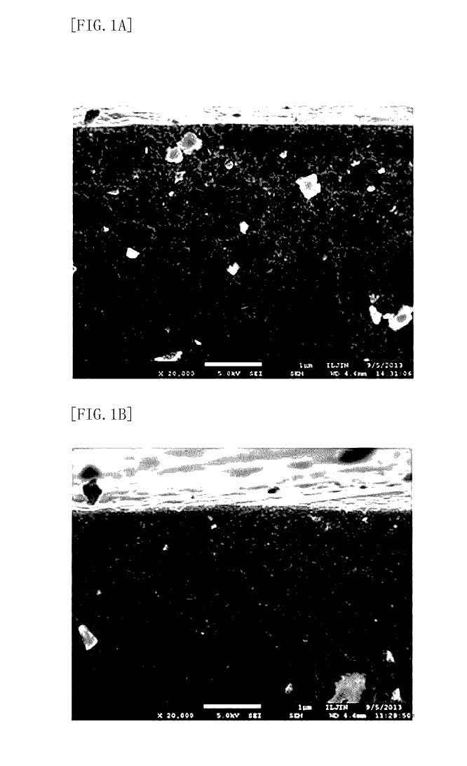

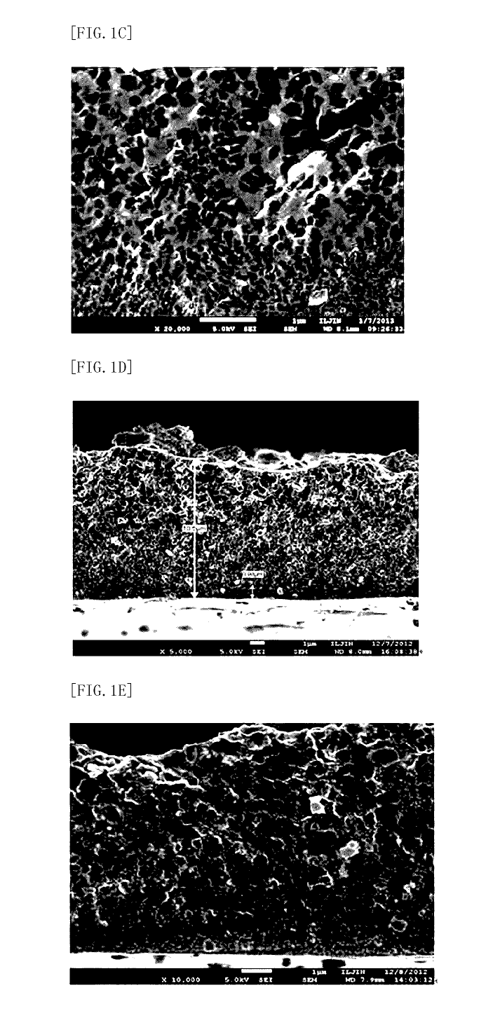

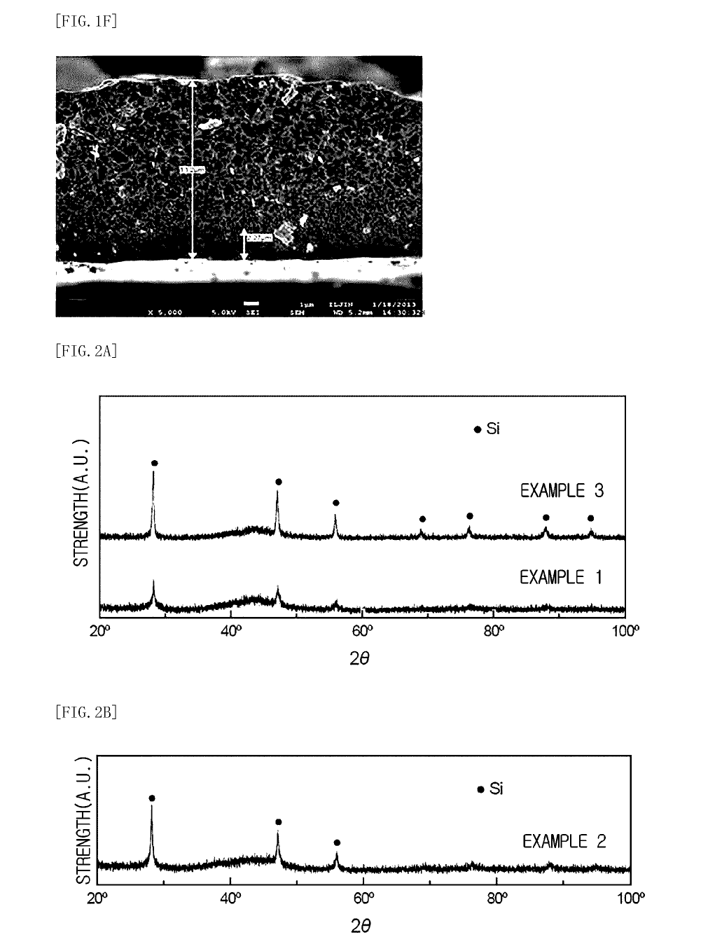

FIGS. 1A to 1C are SEM pictures of enlarged negative electrode active materials of Examples 1 to 3, and FIGS. 1D to 1F are SEM pictures of enlarged negative electrode active materials of Comparative Examples 1 to 3.

Referring to FIGS. 1A to 1F, it can be seen that the negative electrode active materials of Examples 1 to 3 have finer structures than those of the negative electrode active materials of Comparative Examples 1 to 3.

2. XRD Analysis

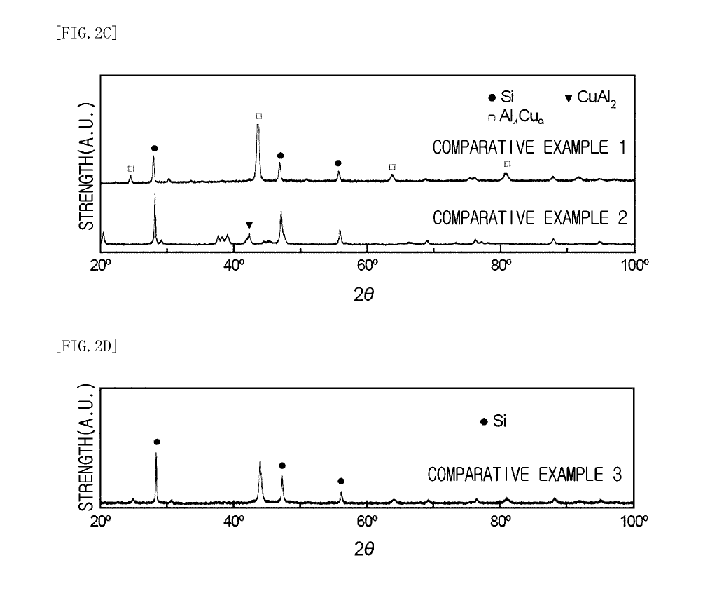

The Cu kαray XRD measurement were performed on the negative electrode active materials of Examples 1 to 3, and Comparative Examples 1 to 3, and the result of the measurement is represented in FIGS. 2A to 2D.

Particularly, FIG. 2A represents XRD data of the negative electrode active materials of Examples 1 and 3, FIG. 2B represents XRD data of the negative electrode active material of Example 2, FIG. 2C represents XRD data of the negative electrode active materials of Comparative Examples 1 and 2, and FIG. 2D represents XRD data of the negative electrode active material of Comparative Example 3.

3. Analysis of the Degree of Amorphization

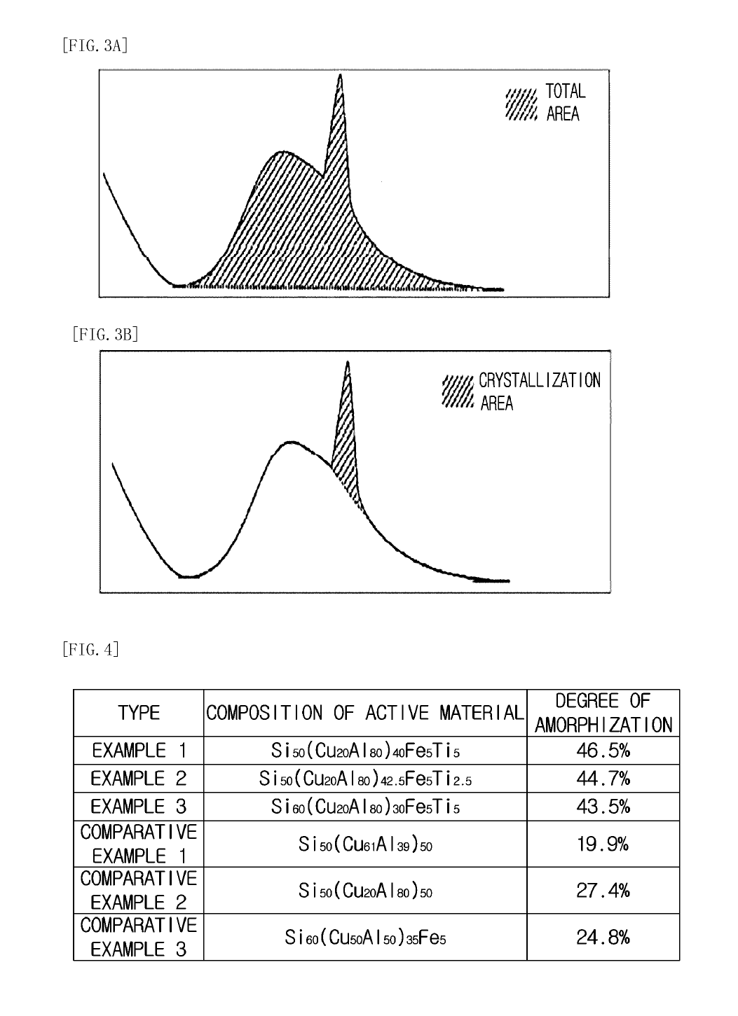

FIGS. 3A and 3B illustrate an example for explaining a calculation of the degree of amorphization based on an XRD pattern represented in FIGS. 2A to 2D.

The degree of amorphization may be obtained by calculating an entire area from FIG. 3A, calculating a crystallization area from FIG. 3B, and then substituting the calculated values to the formula of the degree of amorphization below.

Degree of amorphization (%)=((entire area−crystallization area)÷entire area)×100

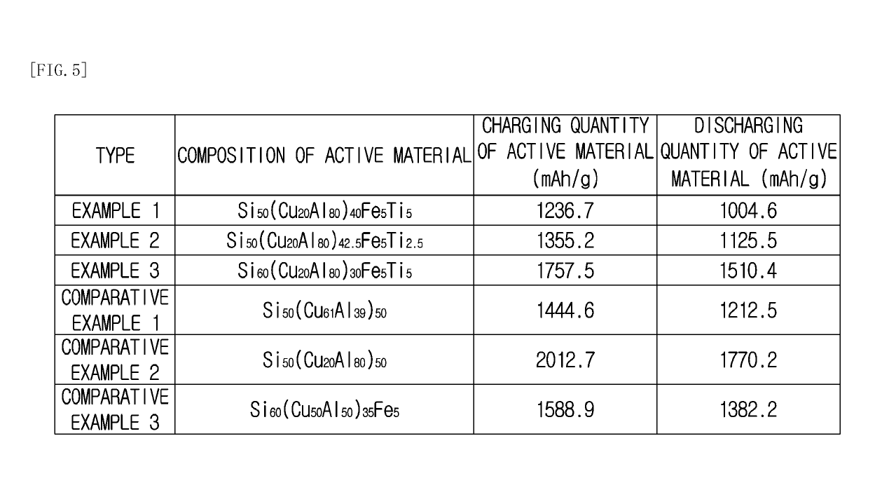

FIG. 4 is a table representing the calculated degrees of amorphization of the negative electrode active materials of Examples 1 to 3, and Comparative Examples 1 to 3.

Referring to FIG. 4, it can be seen that the negative electrode active materials of Examples 1 to 3 have the degree of amorphization of 40% or more, and the negative electrode active materials of Comparative Examples 1 to 3 have the degree of amorphization less than 40%.

4. Active Material Capacity Characteristic

A coin-shaped electrode plate was manufactured by using the negative electrode active materials of Examples 1 to 3, and Comparative Examples 1 to 3, and then the charging/discharging evaluation was performed. Particularly, the electrode plates were manufactured by mixing the negative electrode active materials of Examples 1 to 3, and Comparative Examples 1 and 3, a conductive agent (a KB conductive agent), and a binder (a PI-based binder) in a weight ratio of 86.6:3.4:10.

The charging/discharging was performed on the manufactured electrode plates one time, and then an active material charging quantity (mAh/g), an active material discharging quantity (mAh/g) were measured, and the measurement result is illustrated in FIG. 5.

5. Cycle Life Characteristic

A cycle life characteristic was measured by repeating the charging/discharging 50 times at 0.5 C, and the charging/discharging method was performed under the charging/discharging method for an active material for a lithium secondary battery, which is generally and publicly known in the art.

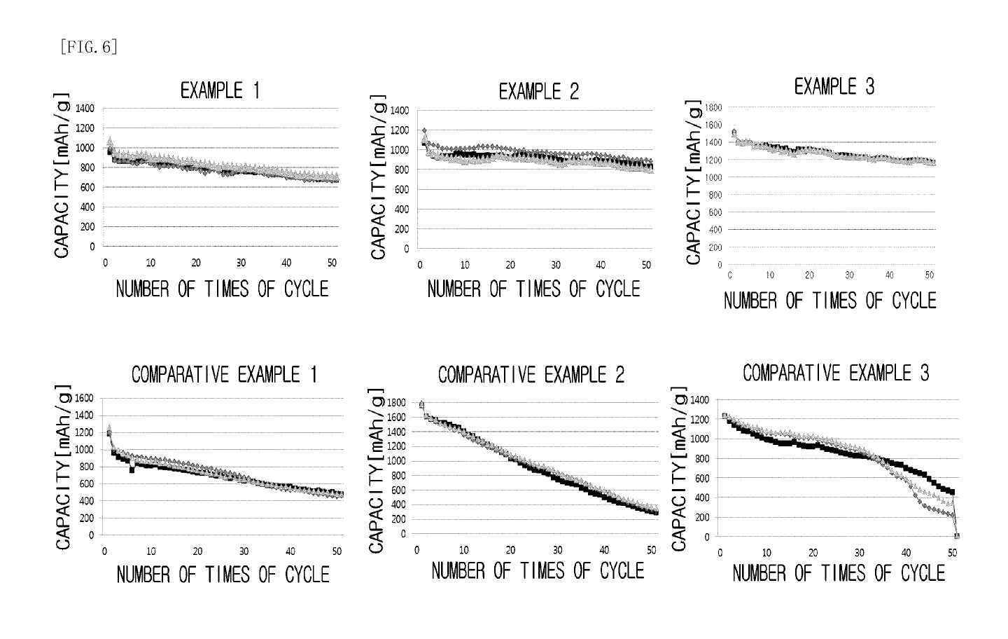

FIG. 6 represents a cycle life characteristic of the negative electrode active materials of Examples 1 to 3, and Comparative Examples 1 to 3 according to the aforementioned charging/discharging.

First, an attention to active material charging quantities and life characteristics of the negative electrode active materials of Comparative Examples 1 and 2 will be given. Referring to FIGS. 5 and 6, it can be seen that the negative electrode active material (the negative electrode active material of Comparative Example 2), in which the ratio of aluminum (Al) to copper (Cu) included in the alloy is 20:80, has a larger active material discharging quantity, but has a poor life characteristic than those of the negative electrode active material (the negative electrode active material of Comparative Example 1), in which the ratio of aluminum (Al) to copper (Cu) included in the alloy is 61:39. Based on the fact, it can be seen that when the ratio of aluminum (Al) to copper (Cu) included in the alloy is low, that is, 20:80, a capacity of the negative electrode active material is improved, but there is a problem in that a life characteristic is degraded.

However, referring back to FIGS. 5 and 6, it can be seen that in the negative electrode active materials of Examples 1 and 2 of the present invention, the aforementioned problem is completely improved, that is, the ratio of aluminum (Al) to copper (Cu) included in the alloy is 20:80, which is low, but a life characteristic is remarkably improved. That is, it can be seen that the negative electrode active materials of Examples 1 and 2 have a relatively larger capacity and a remarkably improved life characteristic.

Further, an attention to the results of Example 3 and Comparative Example 3 represented in FIGS. 5 and 6 will be given.

As described above, when silicon (Si) is added to the negative electrode active material with the large content, a capacity of the negative electrode active material may be improved, but a life characteristic thereof may be degraded. A benefit in return of a value of the negative electrode active material characteristic according to the content of silicon is well represented in Comparative Example 3. As can be seen in the result of Comparative Example 3 represented in FIGS. 5 and 6, silicon (Si) is added to the negative electrode active material with a relatively large content, that is, 60 at %, so that the negative electrode active material of Comparative Example 3 has a large active material discharging quantity of about 1,382 mAh/g, but represents a considerably poor life characteristic.

However, referring to the results of Example 3 represented in FIGS. 5 and 6 of the present invention, it can be seen that even though silicon (Si) is added to the negative electrode active material with a relatively large content, that is, 60 at %, the negative electrode active material of the present invention has a larger active material discharging quantity and a remarkably improved life characteristic compared to the negative electrode active material of Example 3. That is, in the negative electrode active material of the present invention, it is possible to continuously take an advantage of the improvement of a capacity, which is obtainable through the high content of silicon, and minimize the degradation of a life characteristic.

The exemplary embodiments of the present invention have been described in more detail with reference to the accompanying drawings, but the present invention is not essentially limited to the exemplary embodiments, and may be variously modified and carried out within the scope of the technical spirit of the present invention. Accordingly, the various exemplary embodiments disclosed herein are not intended to limit the technical spirit but describe with the true scope and spirit being indicated by the following claims. The scope of the present invention should be construed based on the following appended claims and it should be appreciated that the technical spirit included within the scope equivalent to the claims belongs to the present invention.

1. A negative electrode active material for a lithium secondary battery, comprising:
an alloy including silicon (Si), copper (cu), and aluminum (Al) of 40 to 70 at %,
wherein the ratio of aluminum (Al) to copper (Cu) included in the alloy is substantailly 10:90 to 30:70, and the alloy further includes iron (Fe), and further includes zirconium (Zr) or titanium (Ti).

2. The negative electrode active material of claim 1, wherein the degree of amorphization of the alloy is 40% or more.

3. The negative electrode active material of claim 1, wherein the alloy includes iron (Fe) of 0.1 to 10 at %.

4. The negative electrode active material of claim 1, wherein the alloy includes zirconium (Zr) of 0.1 to 10 at %.

5. The negative electrode active material of claim 1, wherein the alloy includes titanium (Ti) of 0.1 to 10 at %.
